(19) United States
(12) Patent Application Publication
(10) Pub. No.: US 2025/0333074 A1
(43) Pub. Date: Oct. 30, 2025

(54) VEHICULAR INFOTAINMENT SYSTEM WITH DRIVER CUSTOMIZATION MODE

(71) Applicant: Magna Electronics Inc., Auburn Hills, MI (US)

(72) Inventors: Jeremy J. Baca, Ann Arbor, MI (US); Naresh Ravuri, Novi, MI (US)

(21) Appl. No.: 19/191,019

(22) Filed: Apr. 28, 2025

Related U.S. Application Data
(60) Provisional application No. 63/640,297, filed on Apr. 30, 2024.

(51) Int. Cl. B60W 50/14; B60W 40/08; B60W 50/00; B60W 50/08; G06V 20/59; G06V 40/16

(52) U.S. Cl. CPC B60W 50/14; B60W 40/08; B60W 50/082; G06V 20/59; G06V 40/172; B60W 2040/0809; B60W 2050/0083; B60W 2050/146; B60W 2420/403; B60W 2540/043; B60W 2540/215; B60W 2556/10

(57) ABSTRACT

A vehicular configuration system includes a camera disposed at a vehicle and viewing interior of the vehicle. An electronic control unit (ECU) includes an image processor operable to process image data captured by the camera and transferred to the ECU. The vehicular configuration system is operable to determine, via processing at the ECU of image data captured by the camera, whether a driver present within the interior cabin of the vehicle has previously driven the vehicle. The vehicular configuration system, responsive to determining that the driver has not previously driven the vehicle, prompts the driver to select a language for the vehicle to use when communicating with the driver. The vehicular configuration system, in response to receiving input from the driver selecting the language, prompts the driver for configuration of a feature of the vehicle using the selected language.

### CROSS REFERENCE TO RELATED APPLICATION

The present application claims the filing benefits of U.S. provisional application Ser. No. 63/640,297, filed Apr. 30, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular configuration system includes a camera disposed at a vehicle equipped with the vehicular configuration system. The camera views interior of the vehicle. The camera is operable to capture image data. The camera includes a CMOS imaging array that includes at least one million photosensors arranged in rows and columns. The system includes an electronic control unit (ECU) with electronic circuitry and associated software. Image data captured by the camera is transferred to the ECU. The electronic circuitry of the ECU includes an image processor that is operable to process image data captured by the camera and transferred to the ECU. The vehicular configuration system is operable to determine, via processing at the ECU of image data captured by the camera, whether a driver of the vehicle present within the interior cabin of the vehicle has previously driven the vehicle. The vehicular configuration system, responsive to determining that the driver of the vehicle has not previously driven the vehicle, prompts the driver of the vehicle to select a language for the vehicle to use when communicating with the driver of the vehicle. The vehicular configuration system, in response to receiving input from the driver of the vehicle selecting the language, prompts the driver of the vehicle for configuration of a feature of the vehicle using the selected language.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is an exemplary welcome screen for a driver personalization mode of a vehicular configuration system;

FIG. 3 is an exemplary preferred language selection screen for the driver personalization mode of the vehicular configuration system; and

FIG. 4 is an exemplary advanced feature configuration screen for the driver personalization mode of the vehicular configuration system.

### DESCRIPTION OF THE PREFERRED EMBODIMENTS

A vehicular vision system operates to capture images exterior and/or interior of the vehicle and may process the captured image data to display images and to detect objects at or near the vehicle and in the predicted path of the vehicle, such as to assist a driver of the vehicle in maneuvering the vehicle in a rearward direction, or to identify or monitor an occupant of the vehicle. The vehicular vision system includes an image processor or image processing system that is operable to receive image data from one or more cameras and may provide an output to a display device for displaying images representative of the captured image data. Optionally, the vehicular vision system may provide a display, such as a rearview display or a top down or bird's eye or surround view display or the like.

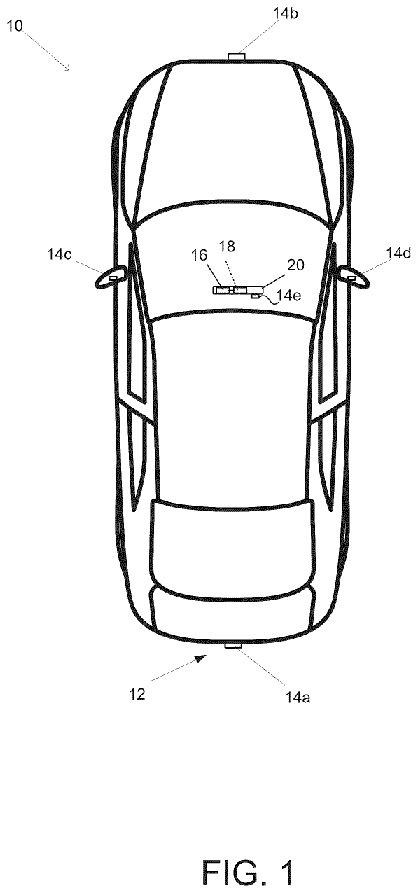

Referring now to the drawings and the illustrative embodiments depicted therein, a vehicle 10 includes an imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). Optionally, the vision system 12 includes an interior viewing camera 14e for a vehicular configuration system, a driver monitoring system and/or an occupant monitoring system. The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provides displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

When entering a vehicle (e.g., a rental car, a shared vehicle, a newly purchased vehicle, etc.) for the first time, it can be overwhelming for a driver (i.e., the end-user) to configure commonly used settings, such as language preferences (e.g., in a foreign country) and any advanced driver assist system (ADAS) features which may be frustrating or unknown to the driver as the car is new to the driver. For example, ADAS features may include automatic emergency braking, lane-keeping assistance (including understanding its level of intervention or steering input), blind-spot monitoring, adaptive cruise control (including setting follow distance preferences), etc. Optionally, ADAS features may include semi-autonomous and/or fully-autonomous driving modes. This impacts the user experience and, in extreme scenarios (e.g., with unknown ADAS features or misunderstood system behavior), can impact the safety of the driver and others on the road. For example, unknown or misunderstood features could result in a driver not using these technologies intended to increase road safety or potentially misinterpreting system actions or warnings.

Implementations herein include a vehicular configuration system with a driver personalization mode for a vehicle to enable the driver to set or configure user profile preferences based on a language preference in the infotainment system that is enabled upon receipt of the vehicle by a rental car agency, a dealer, a pre-owned dealer, an owner of the vehicle, by the driver's request, etc. In some examples, when the driver first enters or turns on/starts the vehicle or provides the request (e.g., via a voice command, touch screen, a button or switch, automatically upon detection of a new driver scenario, etc.), the driver is presented with a request (e.g., via a prompt on the central infotainment display 16) for selection of a language preference (i.e., all supported/possible languages by the system) displayed on a welcome screen or introduction screen. After selection of a preferred language, the driver is guided through commonly used configurations and is provided basic education on any advanced features the car may be equipped with (e.g., seat settings, seat heating, ADAS instruction and control, climate control, mirror position and control, steering wheel adjustments, etc.). This guided process aims to familiarize the driver efficiently.

Whenever the vehicle is provided to a new driver (e.g., rented to a new driver assigned to a new fleet user, being driven by a family member for the first time, etc.), the driver personalization mode may be enabled by the provider or owner of the vehicle in order to allow the new driver to configure the vehicle per their individual preferences and to ensure the driver is educated on important safety and control systems. Optionally, the vehicular configuration system may enable the driver personalization mode responsive to detecting the driver using a vehicular vision system such as a vision system that includes an interior sensing camera and/or driver monitoring camera, and determining, responsive to processing image data captured by the camera, that the driver is a new driver (e.g., using facial recognition technologies and/or by comparing image data captured by the camera with stored image data previously captured by the camera to determine common or different facial characteristics). That is, the vehicular vision system may enable the driver personalization mode responsive to determining that the driver is not associated with a driver profile stored at memory hardware of the vehicular configuration system. Alternatively or additionally, the system may detect a new driver scenario by recognizing a specific key fob designated for new users, detecting the connection of a previously unpaired mobile device (e.g., via Bluetooth or USB), or failing to automatically identify a known driver profile after a certain period or number of ignition cycles, thereby triggering a prompt asking if the current user is a new driver.

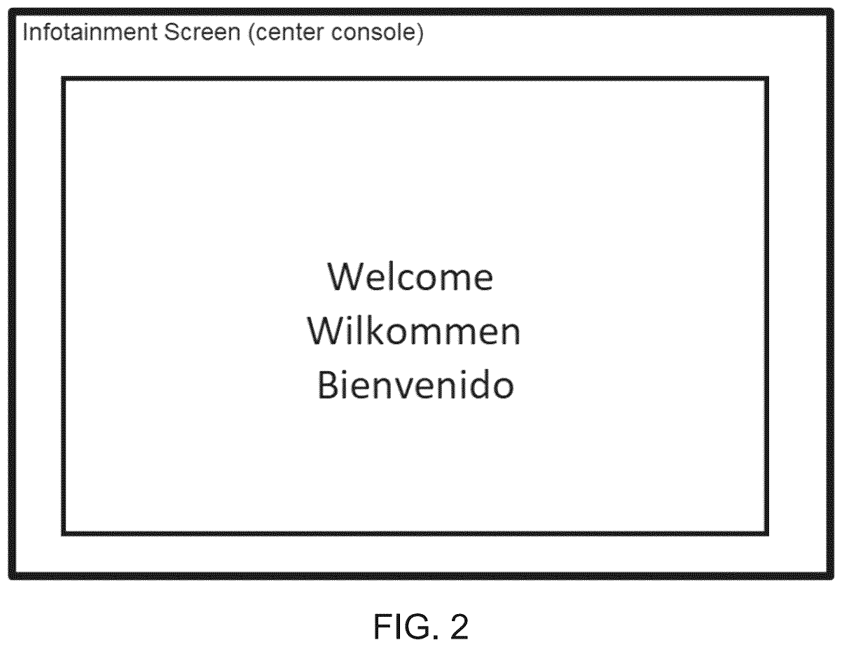

The driver personalization mode may begin with a welcome screen (FIG. 2) that welcomes the driver in one or more languages. Optionally, the driver personalization mode may audibly welcome the driver. In examples where the welcome screen welcomes the driver in more than one language, the vehicular configuration system may present the languages in an order based on which languages are most likely to be a language spoken by the driver. The vehicular configuration system may determine which languages are most likely to be spoken by the driver using global positioning system (GPS) data, a wireless internet connection, and/or geographic settings determined by a manufacturer or the provider or owner of the vehicle (e.g., based on the region of sale or fleet deployment area). The system may suggest a language based on the language setting of a connected smartphone or other user device. For example, the vehicular configuration system may first welcome the driver in English and then French when the vehicular configuration system determines that the vehicle is located in Canada.

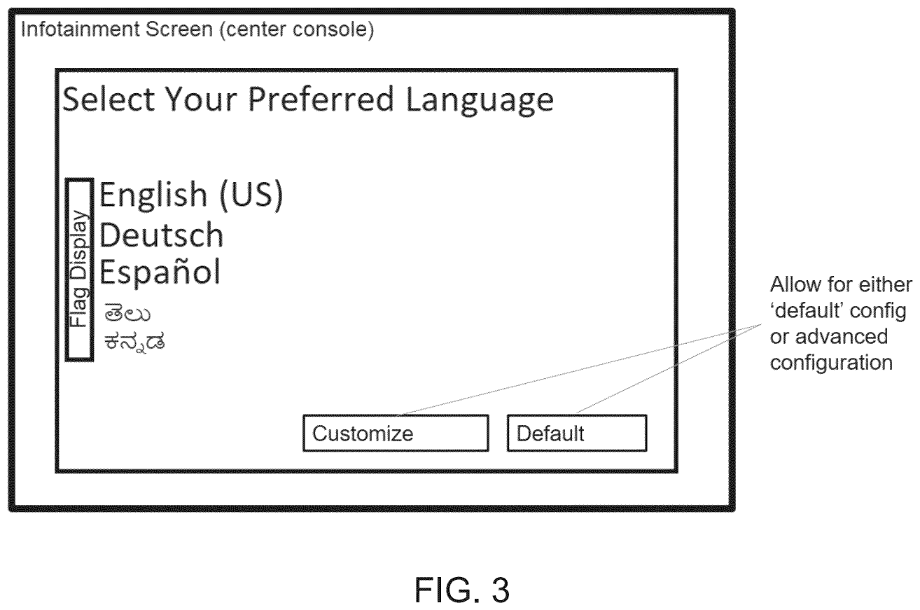

The driver personalization mode guides the driver/user through any number of customization options. For example, the mode may allow the driver to enter infotainment preferences such as preferred language (i.e., the language that the vehicle and driver communicate with via display screens and voice). The mode presents the driver with the languages by displaying a textual list of languages supported by the system, as shown in FIG. 3. Additionally or alternatively, the list may include flag icons associated with the respective languages. The driver may select the language via touchscreen input, physical controls (e.g., rotary dial), voice command, etc. The languages may be displayed alphabetically or in an order based on which languages are most likely to be a language spoken by the driver.

Additionally or alternatively, the driver personalization mode may present the driver with the languages by audibly reciting the languages supported by the system. That is, the driver personalization mode may audibly recite the languages supported by the system in sequence, either alphabetically or in order based on which languages are most likely to be a language spoken by the driver (e.g., based on the geographic location of the vehicle). The audio prompts may recite the name for each language in that respective language. For example, the driver personalization mode of a vehicle located in the United States may audibly recite “English” in English, then recite “Español” in Spanish, then recite “Pǔtōnghuà” in Mandarin. Responsive to the audio prompts, the driver may audibly state a language selection in the respective language. Continuing the above example, the driver may state “Pǔtōnghuà” responsive to the audio prompt, whereby the system may communicate with the driver in Mandarin. The vehicular configuration system thus receives the audibly selected language of the driver, and the vehicular configuration system may adjust all text in displays and/or all audio communications of the vehicle to be in the selected language.

The system may allow the driver to customize settings or features of the vehicle related to media, radio stations, navigation, etc. The driver personalization mode may allow the user to select a default configuration (FIG. 3) that immediately or quickly configures the remaining features based on predefined default values. In some examples, the default values may be predefined by a manufacturer of the vehicle. In other examples, the default values may be determined by the provider or owner of the vehicle. Accordingly, the default values may be predefined and/or determined to maximize user comfort, maximize fuel efficiency of the vehicle, maximize safety of the vehicle, etc. For example, the provider may determine an eco driving mode as a default value in order to reduce fuel consumption of the vehicle. Optionally, multiple default profiles may be offered, such as “Max Safety,” “Comfort,” or “Sporty,” allowing the driver a quick setup aligned with a general preference.

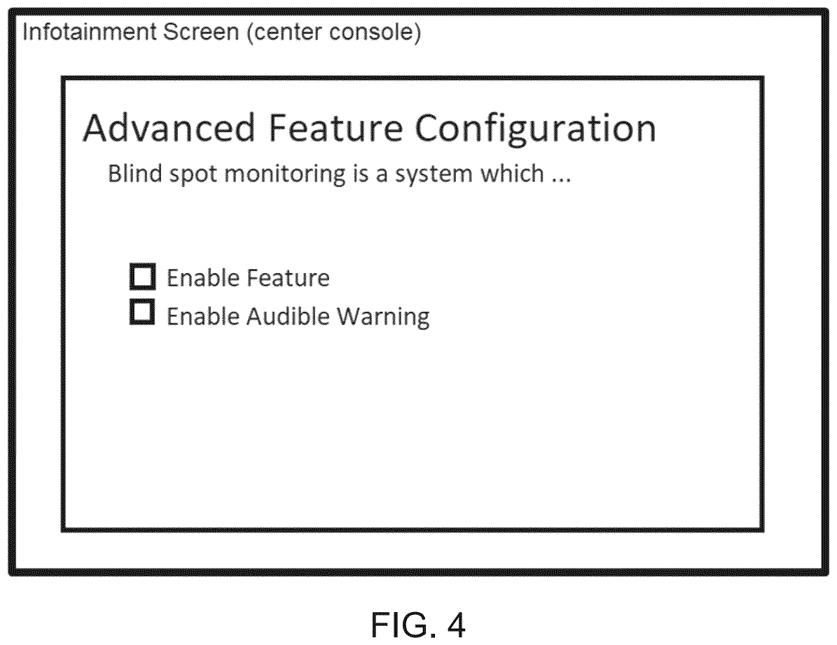

Alternatively, the driver personalization mode may allow the user to select a customized feature configuration and/or advanced feature configuration where the mode then allows the driver to select and/or control additional aspects of the configuration. For example, the advanced feature configuration may allow the user to customize the behavior of one or more ADAS features. As shown in FIG. 4, an advanced feature configuration screen may prompt the user to provide input on whether a blind spot monitoring feature should be enabled and whether an audible warning should be enabled. Further examples include allowing the user to set the follow distance for adaptive cruise control, adjust the sensitivity or intervention level of lane-keeping assist, choose preferred alert types (audible, visual, haptic/vibration) for collision warnings, or enable/disable features like automatic high-beam control.

In some examples, the driver personalization mode allows the driver to configure a seating position of the driver's seat, such as via automatic adjustment of the seat based on the driver's preferred position, which can include a height, a distance from the pedals, and a backrest inclination. This automatic adjustment may be initiated based on driver height estimated by the interior camera 14e and/or recalled from a previously saved profile setting. Additionally or alternatively, the mode allows the driver to configure mirror settings, such as adjustments to the side and/or rearview mirrors to accommodate the driver's sight lines based on the driver's size and seat position. The mode may provide for configuration of a steering wheel position, such as configuration of the steering wheel height and reach to ensure comfortable and safe driving. Additional ergonomic settings such as lumbar support adjustment, seat cushion extension/tilt, and/or headrest position may be included in the configuration process.

The driver personalization mode may guide the driver through configuration of the climate control system. For example, the mode prompts for the driver for input regarding personal preferences for temperature settings, fan settings, air distribution preferences (e.g., dash, floor, defrost), enabling/disabling features like automatic recirculation or synchronized dual-zone settings, etc. These settings may be saved so that the vehicle automatically adjusts the climate controls to suit the driver upon future entry.

The vehicular configuration system and the driver personalization mode may allow the driver to configure one or more displays of the vehicle. For example, the mode may prompt for adjustment of the dashboard display to show information relevant to the driver, such as fuel efficiency, tire pressure, media information, and/or navigation details. Configuration may extend to a head-up display (HUD), allowing selection of displayed information and adjustment of position/brightness. Infotainment screen layout preferences or ambient lighting color/intensity may be configured. The vehicular configuration system may allow for configuration of different driving modes (e.g., sport modes, eco modes, four-wheel drive modes, comfort modes, off-road modes, towing modes, customizing individual parameters like throttle response and suspension stiffness, etc.) based on the driver's preferred driving mode. For electric or hybrid vehicles, configuration may include setting preferred levels of regenerative braking. These are merely intended as examples, as the vehicular configuration system and driver personalization mode may allow the driver to configure any or all adjustable features of the vehicle. The driver personalization mode may include a description and/or infographic (optionally including short video clips or interactive tutorials) that explains the configurable feature, setting options, driving modes, etc., and allow the user or driver to enable/disable any identified feature offered by the vehicle.

Optionally, the vehicular configuration system may allow the provider or owner of the vehicle to determine settings or features of the vehicle that the driver may configure via the driver personalization mode. That is, the provider or owner of the vehicle may determine a subset of settings or features that the driver personalization mode will allow the driver to determine. This determination may be made via a separate administrative interface, a fleet management software portal accessible remotely, specific settings within the vehicle protected by an administrative password or key, etc. The vehicular configuration system may allow the provider or owner to determine default values for remaining settings or features that the provider or owner excludes from the subset of settings or features. For example, the provider or owner (such as a rental agency concerned about misuse or excessive wear) may determine that the driver personalization mode will allow the driver to configure mirror settings, climate control system settings, and dashboard display information via the driver personalization mode, and the provider or owner may determine default values for the ADAS features (e.g., ensuring AEB is always enabled) and the driving modes (e.g., locking the vehicle in ECO mode). This allows owners/providers to balance driver customization with operational requirements or safety policies.

The vehicular configuration system may store all selections/configurations provided by the driver to a driver profile associated with the current driver. The vehicle may recall the profile and use the stored selections/configurations during future use of the vehicle by the driver. For example, the system may detect or identify the driver using the interior sensing camera or driver monitoring camera, or the like (e.g., using facial recognition technologies). Alternatively or additionally, the profile recall may be triggered by recognizing a specific paired smartphone via Bluetooth, detecting a specific key fob, manual selection from a list of profiles displayed on screen, a voice command identifying the driver, and/or reading profile data from an NFC/RFID tag or card. The profile data may be stored locally within the vehicle's memory or optionally synchronized with a cloud-based user account accessible across multiple vehicles. The system may include logic to handle situations where multiple recognized drivers are detected simultaneously (e.g., by prompting for selection of a recognized user).

The vehicular configuration system includes a driver personalization mode that enables configuration of settings and features of the vehicle when a driver uses the vehicle for the first time and may be unaware of the features and systems equipped at the vehicle to configure. The driver personalization mode may be enabled by a provider or owner of the vehicle when the driver first receives the vehicle. Additionally or alternatively, the vehicular configuration system may enable the driver personalization mode responsive to detecting the driver using an interior sensing camera or driver monitoring camera and determining, responsive to processing image data captured by the camera, that the driver is a new driver. The vehicular configuration system improves convenience and user experience of the vehicle by enabling the driver to select and interact with the vehicle in a preferred language of the driver. The vehicular configuration system improves safety of the vehicle for the driver by allowing the new driver to configure the vehicle per their individual preferences and to ensure the driver is educated on important safety and control systems.

The driver monitoring camera may be disposed at the interior rearview mirror assembly of the vehicle and view at least a driver head region within the cabin of the vehicle. For example, the camera may be disposed within a mirror head of the mirror assembly and behind the mirror reflective element, such that the camera moves in tandem with the mirror head and views through the mirror reflective element. Optionally, a near infrared light emitter may be disposed at the mirror head to illuminate at least the driver head region within the interior cabin of the vehicle. The mirror reflector may comprise a transflective mirror reflector that is transmissive of near infrared light (such as near infrared light emitted by the light emitter and reflected off objects within the interior cabin of the vehicle), and the camera may be sensitive to near infrared light.

The vehicular configuration system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. provisional application Ser. No. 63/673,225, filed Jul. 19, 2024, and/or U.S. provisional application Ser. No. 63/641,574, filed May 2, 2024, and/or International Publication No. WO 2023/220222, which are all hereby incorporated herein by reference in their entireties.

Optionally, the driver monitoring system may be integrated with a camera monitoring system (CMS) of the vehicle. The integrated vehicle system incorporates multiple inputs, such as from the inward viewing or driver monitoring camera and from the forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The rearward viewing camera may comprise a rear backup camera of the vehicle or may comprise a centrally located higher mounted camera (such as at a center high-mounted stop lamp (CHMSL) of the vehicle), whereby the rearward viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Publication Nos. US-2024-0064274; US-2021-0245662; US-2021-0162926; US-2021-0155167; US-2018-0134217 and/or US-2014-0285666, which are all hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular configuration system, the vehicular configuration system comprising:
a camera disposed at a vehicle equipped with the vehicular configuration system, the camera viewing within an interior cabin of the vehicle;
wherein the camera is operable to capture image data;
wherein the camera comprises a CMOS imaging array, and wherein the CMOS imaging array comprises at least one million photosensors arranged in rows and columns;
an electronic control unit (ECU) comprising electronic circuitry and associated software;
wherein image data captured by the camera is transferred to the ECU;
wherein the electronic circuitry of the ECU comprises an image processor that is operable to process image data captured by the camera and transferred to the ECU;
wherein the vehicular configuration system is operable to determine, based in part on processing at the ECU of image data captured by the camera, whether a driver of the vehicle present within the interior cabin of the vehicle has previously driven the vehicle;
wherein the vehicular configuration system, responsive to determining that the driver of the vehicle has not previously driven the vehicle, prompts the driver of the vehicle to select a language for the vehicle to use when communicating with the driver of the vehicle; and
wherein the vehicular configuration system, in response to receiving input from the driver of the vehicle selecting the language, prompts the driver of the vehicle for configuration of a feature of the vehicle using the selected language.

2. The vehicular configuration system of claim 1, wherein the feature comprises an advanced driver assistance system feature.

3. The vehicular configuration system of claim 1, wherein the feature comprises at least one selected from the group consisting of (i) a seat setting of the vehicle, (ii) an infotainment system feature, (iii) a climate control feature, (iv) a mirror feature, (v) a steering wheel feature, (vi) a display configuration and (vii) a driving mode feature.

4. The vehicular configuration system of claim 1, wherein the vehicular configuration system, in response to receiving additional input from the driver of the vehicle configuring the feature, stores the configuration of the feature with a driver profile associated with the driver of the vehicle.

5. The vehicular configuration system of claim 4, wherein the vehicular configuration system, responsive to identifying the driver of the vehicle during a future use of the vehicle by the driver of the vehicle, configures the feature of the vehicle based on the driver profile associated with the driver of the vehicle.

6. The vehicular configuration system of claim 1, wherein the prompt for configuration of the feature of the vehicle comprises (i) a default configuration mode and (ii) an advanced configuration mode.

7. The vehicular configuration system of claim 6, wherein the vehicular configuration system, in response to the driver of the vehicle selecting the advanced configuration mode, provides a description of the feature.

8. The vehicular configuration system of claim 7, wherein the description of the feature comprises at least one selected from the group consisting of (i) an infographic, (ii) a short video clip and (iii) an interactive tutorial.

9. The vehicular configuration system of claim 1, wherein the camera captures image data for a driver monitoring system of the vehicle.

10. The vehicular configuration system of claim 9, wherein the camera is disposed at an interior rearview mirror assembly of the vehicle.

11. The vehicular configuration system of claim 1, wherein the vehicular configuration system determines an order for presenting languages during the prompt to select a language, and wherein the order is based at least in part on a current geographic location of the vehicle.

12. The vehicular configuration system of claim 1, wherein the vehicular configuration system determines whether the driver of the vehicle present within the interior cabin of the vehicle has previously driven the vehicle based on comparison of image data captured by the camera with stored image data previously captured by the camera.

13. The vehicular configuration system of claim 1, wherein the vehicular configuration system, responsive to determining that the driver of the vehicle has previously driven the vehicle, (i) communicates with the driver using the driver's previous language selection when communicating with the driver of the vehicle and (ii) configures the feature of the vehicle in accordance with the driver's previous configuration.

14. The vehicular configuration system of claim 1, wherein the vehicular configuration system prompts the driver of the vehicle to select the language for the vehicle to use when communicating with the driver of the vehicle via a display screen.

15. A vehicular configuration system, the vehicular configuration system comprising:
a camera disposed at a vehicle equipped with the vehicular configuration system, the camera viewing within an interior cabin of the vehicle;
wherein the camera is operable to capture image data;
wherein the camera comprises a CMOS imaging array, and wherein the CMOS imaging array comprises at least one million photosensors arranged in rows and columns;
an electronic control unit (ECU) comprising electronic circuitry and associated software;
wherein image data captured by the camera is transferred to the ECU;
wherein the electronic circuitry of the ECU comprises an image processor that is operable to process image data captured by the camera and transferred to the ECU;
wherein the vehicular configuration system is operable to determine, based in part on processing at the ECU of image data captured by the camera, whether a driver of the vehicle present within the interior cabin of the vehicle has previously driven the vehicle;
wherein the vehicular configuration system, responsive to determining that the driver of the vehicle has not previously driven the vehicle, prompts the driver of the vehicle to select a language for the vehicle to use when communicating with the driver of the vehicle;
wherein the vehicular configuration system, in response to receiving input from the driver of the vehicle selecting the language, prompts the driver of the vehicle for configuration of a feature of the vehicle using the selected language;
wherein the prompt for configuration of the feature of the vehicle comprises (i) a default configuration mode and (ii) an advanced configuration mode; and
wherein the vehicular configuration system, in response to receiving additional input from the driver of the vehicle configuring the feature, stores the configuration of the feature with a driver profile associated with the driver of the vehicle.

16. The vehicular configuration system of claim 15, wherein the vehicular configuration system, responsive to identifying the driver of the vehicle during a future use of the vehicle by the driver of the vehicle, configures the feature of the vehicle based on the driver profile associated with the driver of the vehicle.

17. The vehicular configuration system of claim 15, wherein the vehicular configuration system determines whether the driver of the vehicle present within the interior cabin of the vehicle has previously driven the vehicle based on comparison of image data captured by the camera with stored image data previously captured by the camera.

18. The vehicular configuration system of claim 15, wherein the vehicular configuration system, responsive to determining that the driver of the vehicle has previously driven the vehicle, (i) communicates with the driver using the driver's previous language selection when communicating with the driver of the vehicle and (ii) configures the feature of the vehicle in accordance with the driver's previous configuration.

19. A vehicular configuration system, the vehicular configuration system comprising:
a camera disposed at a vehicle equipped with the vehicular configuration system, the camera viewing within an interior cabin of the vehicle;
wherein the camera is operable to capture image data;
wherein the camera comprises a CMOS imaging array, and wherein the CMOS imaging array comprises at least one million photosensors arranged in rows and columns;
an electronic control unit (ECU) comprising electronic circuitry and associated software;
wherein image data captured by the camera is transferred to the ECU;
wherein the electronic circuitry of the ECU comprises an image processor that is operable to process image data captured by the camera and transferred to the ECU;
wherein the vehicular configuration system is operable to determine, based in part on processing at the ECU of image data captured by the camera, whether a driver of the vehicle present within the interior cabin of the vehicle has previously driven the vehicle;
wherein the vehicular configuration system determines whether the driver of the vehicle present within the interior cabin of the vehicle has previously driven the vehicle based on comparison of image data captured by the camera with stored image data previously captured by the camera;
wherein the vehicular configuration system, responsive to determining that the driver of the vehicle has not previously driven the vehicle, prompts the driver of the vehicle to select a language for the vehicle to use when communicating with the driver of the vehicle;
wherein the vehicular configuration system, in response to receiving input from the driver of the vehicle selecting the language, prompts the driver of the vehicle for configuration of a feature of the vehicle using the selected language; and
wherein the vehicular configuration system, responsive to determining that the driver of the vehicle has previously driven the vehicle, (i) communicates with the driver using the driver's previous language selection when communicating with the driver of the vehicle and (ii) configures the feature of the vehicle in accordance with the driver's previous configuration.

20. The vehicular configuration system of claim 19, wherein the feature comprises at least one selected from the group consisting of (i) a seat setting of the vehicle, (ii) an infotainment system feature, (iii) a climate control feature, (iv) a mirror feature, (v) a steering wheel feature, (vi) a display configuration, (vii) a driving mode feature and (viii) an advanced driver assistance system feature.

21. The vehicular configuration system of claim 19, wherein the prompt for configuration of the feature of the vehicle comprises (i) a default configuration mode and (ii) an advanced configuration mode, and wherein the vehicular configuration system, in response to the driver of the vehicle selecting the advanced configuration mode, provides a description of the feature.

22. The vehicular configuration system of claim 19, wherein the vehicular configuration system determines an order for presenting languages during the prompt to select a language, and wherein the order is based at least in part on a current geographic location of the vehicle.
